(19) United States
(12) Patent Application Publication
(10) Pub. No.: US 2022/0289188 A1
(43) Pub. Date: Sep. 15, 2022

(54) DEVICE AND METHOD FOR CONTROLLING DEVICE

(71) Applicant: WOVEN ALPHA, INC., Tokyo (JP)

(72) Inventor: Sho Mikuriya, Yokohama-shi (JP)

(21) Appl. No.: 17/654,922

(22) Filed: Mar. 15, 2022

(30) Foreign Application Priority Data
Mar. 15, 2021 (JP) 2021-041549

(51) Int. Cl. B60W 30/14

(52) U.S. Cl. CPC B60W 30/143; B60W 2720/106; B60W 2710/18

(57) ABSTRACT

A control device of a vehicle includes a processor configured to modify target acceleration/deceleration of the vehicle according to acceleration/deceleration required of the vehicle in automated driving control of the vehicle. The target acceleration/deceleration is included in a first acceleration/deceleration request received via a communication interface from a driving assistance controller for assisting a driver of the vehicle in driving. The processor outputs a second acceleration/deceleration request including the modified target acceleration/deceleration via the communication interface to an accelerator controller.

### FIELD

The present invention relates to a control device and a method for automated driving control of a vehicle.

### BACKGROUND

To assist drivers in driving vehicles, a controller for controlling the accelerators, brakes, or steering of the vehicles depending on desired purposes of control has been developed (see Japanese Unexamined Patent Publication No. 2020-100244).

A travel controller disclosed in Japanese Unexamined Patent Publication No. 2020-100244 includes a first travel control unit that controls a host vehicle so as to track a leading vehicle by sliding mode control, using a target sliding mode surface (SM surface) including a target travel state, and a second travel control unit that controls travel of the host vehicle until its travel state converges to the target SM surface. Specifically, the second travel control unit repeats the following steps until the travel state of the host vehicle converges to the target SM surface: determining acceleration/deceleration of the host vehicle so as to realize the target travel state, based on deviation of its travel state from the target travel state; modifying and setting target acceleration/deceleration so that the acceleration/deceleration of the host vehicle may fall within a certain range; and controlling travel of the host vehicle so as to reach the target acceleration/deceleration.

### SUMMARY

A vehicle controller for driving assistance automatically controls the motion of a vehicle, but may not accept input that will cause the vehicle to execute control deviating from the intended function of driving assistance.

It is an object of the present invention to provide a control device of a vehicle that enables automated driving control of the vehicle with a vehicle controller for driving assistance.

According to an embodiment, a control device of a vehicle is provided. The control device includes a processor configured to modify target acceleration/deceleration of the vehicle according to acceleration/deceleration required of the vehicle in automated driving control of the vehicle. The target acceleration/deceleration is included in a first acceleration/deceleration request received via a communication interface from a driving assistance controller for assisting a driver of the vehicle in driving. The processor outputs a second acceleration/deceleration request including the modified target acceleration/deceleration via the communication interface to an accelerator controller for controlling an accelerator of the vehicle.

It is preferable that the processor of the control device is further configured to modify target deceleration of the vehicle by braking force of a brake of the vehicle according to deceleration by braking force of the brake required in automated driving control of the vehicle. The target deceleration is included in a first braking request received via the communication interface. The processor outputs a second braking request including the modified target deceleration via the communication interface to a brake controller for controlling the brake.

When the acceleration/deceleration required of the vehicle in automated driving control of the vehicle indicates deceleration of the vehicle, the processor of the control device preferably modifies the target deceleration included in the first braking request according to the deceleration by braking force of the brake required in automated driving control of the vehicle. When the acceleration/deceleration required of the vehicle in automated driving control of the vehicle indicates acceleration of the vehicle, the processor preferably does not modify the target deceleration included in the first braking request.

According to another embodiment, a method for controlling a vehicle is provided. The method includes modifying target acceleration/deceleration of the vehicle according to acceleration/deceleration required of the vehicle in automated driving control of the vehicle. The target acceleration/deceleration is included in a first acceleration/deceleration request received via a communication interface from a driving assistance controller for assisting a driver of the vehicle in driving. The method further includes outputting a second acceleration/deceleration request including the modified target acceleration/deceleration via the communication interface to an accelerator controller for controlling an accelerator of the vehicle.

The vehicle control device according to the present invention has an advantageous effect of enabling automated driving control of the vehicle with a vehicle controller for driving assistance.

### BRIEF DESCRIPTION OF DRAWINGS

FIG. 1 schematically illustrates the configuration of a vehicle control system equipped with a control device of a vehicle.

FIG. 2 illustrates the hardware configuration of an electronic control unit, which is an embodiment of the vehicle control device.

FIG. 3 is a functional block diagram of a processor of the electronic control unit, related to a vehicle control process.

FIG. 4 is an operation flowchart of the vehicle control process.

### DESCRIPTION OF EMBODIMENTS

Hereinafter, a control device of a vehicle and a method for controlling a vehicle executed by the control device will be described with reference to the drawings. The control device is, for example, retrofitted to a vehicle equipped with a controller for assisting a driver of the vehicle in driving (hereafter, a “driving assistance controller”), separately from the driving assistance controller, and executes automated driving control of the vehicle with the driving assistance controller. For this purpose, the control device receives an acceleration/deceleration request signal including target acceleration/deceleration of the vehicle from the driving assistance controller, modifies the target acceleration/deceleration according to acceleration/deceleration required of the vehicle in automated driving control of the vehicle, and outputs an acceleration/deceleration request signal including the modified target acceleration/deceleration to an accelerator controller for controlling an accelerator of the vehicle. Additionally, the control device receives from the accelerator controller a braking request signal including target deceleration of the vehicle by braking force of a brake of the vehicle, modifies the target deceleration according to deceleration by braking force of the brake required of the vehicle in automated driving control of the vehicle, and outputs a braking request signal including the modified target deceleration to a brake controller for controlling the brake. In this way, the control device changes the target acceleration/deceleration and the target deceleration respectively included in an acceleration/deceleration request signal and a braking request signal with which the driving assistance controller controls the accelerator and the brake to values for automated driving control, enabling automated driving control of the vehicle with the format of the acceleration/deceleration request signal and the braking request signal.

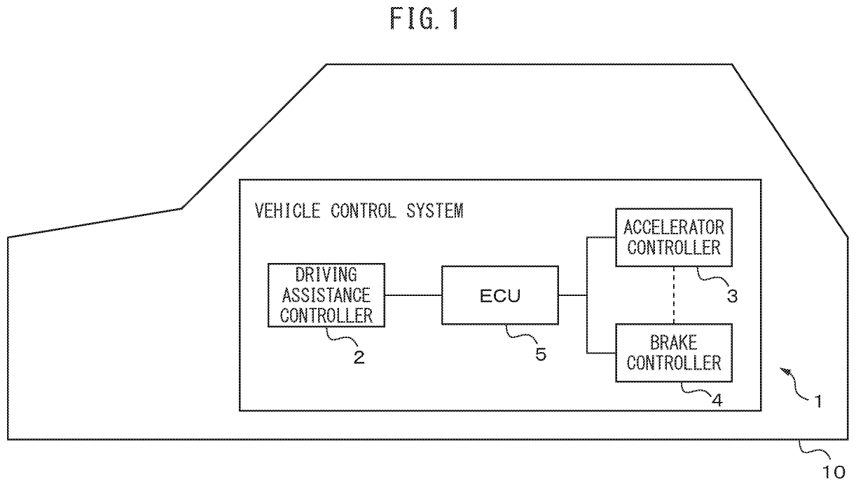

FIG. 1 schematically illustrates the configuration of a vehicle control system equipped with a control device of a vehicle. In the present embodiment, the vehicle control system 1, which is mounted on a vehicle 10 and controls the vehicle 10, includes a driving assistance controller 2, an accelerator controller 3, a brake controller 4, and an electronic control unit (ECU) 5, which is an example of a control device of the vehicle 10 according to the present embodiment. The driving assistance controller 2, the accelerator controller 3, and the brake controller 4 are connected to the ECU 5 so that they can communicate with each other. The vehicle control system 1 may further include at least one camera (not illustrated) for capturing the surroundings of the vehicle 10; at least one distance sensor (not illustrated), such as LiDAR, radar, or sonar, for measuring the distances to objects around the vehicle 10, and a storage device (not illustrated) that contains map information used for automated driving control of the vehicle 10. The vehicle control system 1 may further include a receiver (not illustrated) for determining the position of the vehicle 10 in conformity with a satellite positioning system, such as a GPS receiver; a wireless communication terminal (not illustrated) for wireless communication with another device; and a navigation device (not illustrated) for searching for a planned travel route of the vehicle 10.

The driving assistance controller 2 controls the vehicle 10 to assist a driver of the vehicle 10 in driving under a predetermined situation. In the present embodiment, the driving assistance controller 2 at least sets acceleration/deceleration required of the vehicle 10 for the purpose of driving assistance under a predetermined situation. The predetermined situation is, for example, one in which the distance between the vehicle 10 and another vehicle traveling ahead thereof should be kept constant, and the driving assistance controller 2 is a controller for active cruise control. Alternatively, the predetermined situation is one in which the vehicle 10 is steered for parking, and the driving assistance controller 2 is a controller for automatically parking the vehicle 10.

In the present embodiment, the driving assistance controller 2 is set to operate during automated driving control of the vehicle 10, by the ECU 5 or with a switch provided in the interior of the vehicle 10 for setting whether to run a driving assistance process. During automated driving control of the vehicle 10, the driving assistance controller 2 outputs acceleration/deceleration request signals each including target acceleration/deceleration of the vehicle 10 (first acceleration/deceleration requests) at predetermined intervals. The target acceleration/deceleration is represented by a positive signal value at accelerating the vehicle 10 and by a negative signal value at decelerating the vehicle 10. During automated driving control of the vehicle 10, the target acceleration/deceleration included in each acceleration/deceleration request signal that the driving assistance controller 2 outputs is modified by the ECU 5, and thus not actually used for automated driving control of the vehicle 10.

The accelerator controller 3 controls the accelerator of the vehicle 10 according to acceleration/deceleration request signals received from the driving assistance controller 2 or acceleration/deceleration request signals received from the ECU 5 (second acceleration/deceleration requests) so that the acceleration/deceleration of the vehicle 10 may approach the target acceleration/deceleration included in the acceleration/deceleration request signals. In the present embodiment, the accelerator controller 3 controls the accelerator of the vehicle 10 according to acceleration/deceleration request signals received from the ECU 5, while the ECU 5 is executing automated driving control of the vehicle 10.

For example, the accelerator controller 3 stores a reference table representing a correspondence between target acceleration/deceleration and accelerator positions, and determines the accelerator position corresponding to the target acceleration/deceleration by referring to the reference table. The accelerator controller 3 then controls the accelerator so that it may be at the determined accelerator position. The amount of fuel injection in the engine of the vehicle 10 or the electric power supply to a driving motor of the vehicle 10 is controlled depending on the accelerator position.

Additionally, the accelerator controller 3 calculates target deceleration corresponding to braking force exerted by the brake of the vehicle 10, depending on the target acceleration/deceleration, and outputs braking request signals including the target deceleration (first braking requests). To this end, the accelerator controller 3 may calculate the target deceleration by referring to the speed of the vehicle 10 received via the brake controller 4 from a vehicle speed sensor (not illustrated) provided for the vehicle 10. For example, when the target acceleration/deceleration indicates acceleration of the vehicle 10, the accelerator controller 3 sets the target deceleration also at a value corresponding to acceleration of the vehicle 10 (e.g., a positive value). However, when the vehicle 10 at rest starts, the vehicle 10 preferably accelerates and also applies the brake to a certain extent for the purpose of a smooth start, and gradually releases the brake. Thus, when the speed of the vehicle 10 is not greater than a predetermined speed threshold corresponding to a start of the vehicle 10, the accelerator controller 3 may set the target deceleration at a value such that braking force is exerted by the brake (e.g., a negative value). During automated driving control of the vehicle 10, the target deceleration represented by each braking request signal is modified by the ECU 5, and thus not actually used for automated driving control of the vehicle 10.

The brake controller 4 controls the brake of the vehicle 10 according to braking request signals received from the accelerator controller 3 or braking request signals received from the ECU 5 (second braking requests) so that the deceleration of the vehicle 10 may approach the target deceleration included in the braking request signals. In the present embodiment, the brake controller 4 controls the brake of the vehicle 10 according to braking request signals received from the ECU 5, while the ECU 5 is executing automated driving control of the vehicle 10. For example, the brake controller 4 stores a reference table representing a correspondence between target deceleration and braking force, and determines the braking force corresponding to the target deceleration by referring to the reference table. The brake controller 4 then controls the brake so that the determined braking force may be exerted. Additionally, the brake controller 4 may output a signal indicating whether the brake has operated to the driving assistance controller 2 or the accelerator controller 3.

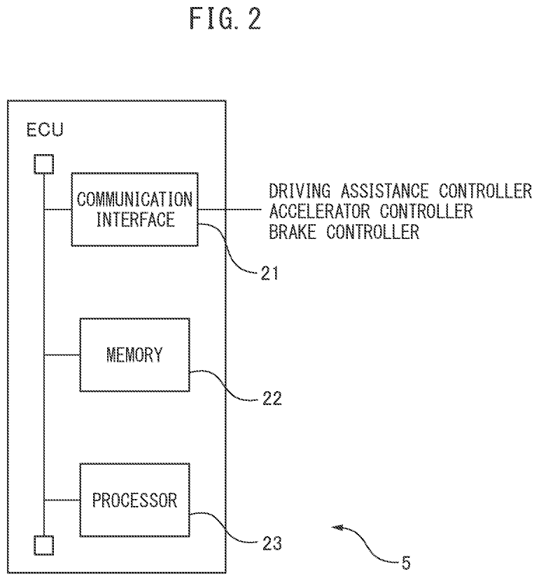

FIG. 2 illustrates the hardware configuration of the ECU 5. The ECU 5 executes automated driving control of the vehicle 10 with the driving assistance controller 2. For this purpose, the ECU 5 includes a communication interface 21, a memory 22, and a processor 23. The communication interface 21, the memory 22, and the processor 23 may be different circuits or a single integrated circuit.

The communication interface 21 is an example of the communication unit, and includes an interface circuit for connecting the ECU 5 to the driving assistance controller 2, the accelerator controller 3, and the brake controller 4. Every time the communication interface 21 receives an acceleration/deceleration request signal from the driving assistance controller 2, the communication interface 21 passes the received acceleration/deceleration request signal to the processor 23. Every time the communication interface 21 receives a braking request signal from the accelerator controller 3, the communication interface 21 passes the received braking request signal to the processor 23. Additionally, the communication interface 21 outputs an acceleration/deceleration request signal modified by the processor 23 to the accelerator controller 3 and a braking request signal modified by the processor 23 to the brake controller 4. The communication interface 21 may further output a control signal for controlling the steering of the vehicle 10 received from the processor 23 to a controller (not illustrated) of the steering.

Additionally, the communication interface 21 passes to the processor 23 an image representing the surroundings of the vehicle 10 and received from the camera (not illustrated), a ranging signal received from the distance sensor (not illustrated), a positioning signal received from the GPS receiver (not illustrated), a signal received via the wireless communication terminal (not illustrated) from another device outside the vehicle 10, or a signal representing a planned travel route of the vehicle 10 and received from the navigation device (not illustrated).

The memory 22 is an example of a storage unit, and includes, for example, volatile and nonvolatile semiconductor memories. The memory 22 contains an algorithm of a vehicle control process executed by the processor 23 of the ECU 5, and various types of data and parameters used in the vehicle control process. For example, the memory 22 contains map information and a set of parameters for specifying a classifier used in the vehicle control process. The memory 22 further contains various types of data generated during the vehicle control process for a certain period.

The processor 23 is an example of a control unit. In the present embodiment, the processor 23 includes, for example, one or more central processing units (CPUs) and a peripheral circuit thereof. The processor 23 may further include an operating circuit used for a predetermined operation, such as an arithmetic circuit or a graphics processing unit (GPU).

The processor 23 executes the vehicle control process during automated driving control of the vehicle 10.

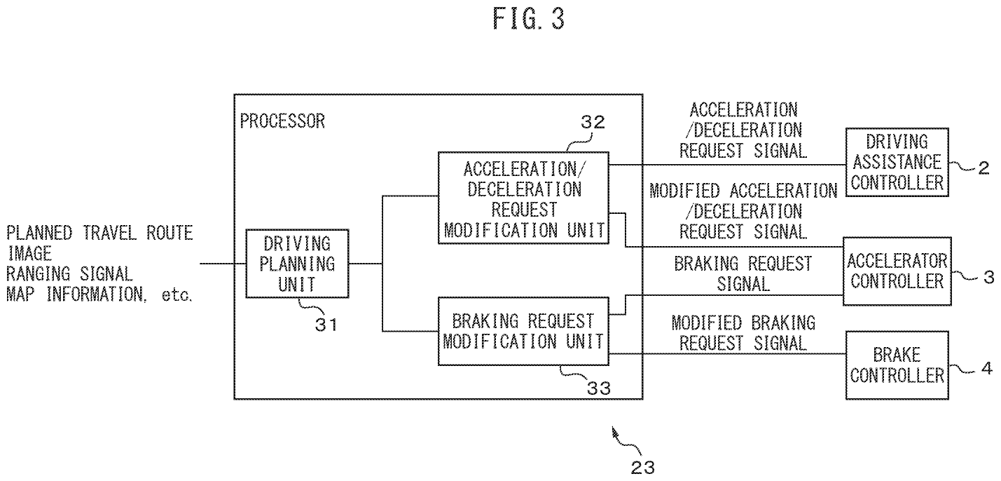

FIG. 3 is a functional block diagram of the processor 23 of the ECU 5 related to the vehicle control process. The processor 23 includes a driving planning unit 31, an acceleration/deceleration request modification unit 32, and a braking request modification unit 33. These units included in the processor 23 are, for example, functional modules implemented by a computer program executed on the processor 23, or may be dedicated operating circuits implemented in the processor 23.

During automated driving control of the vehicle 10, the driving planning unit 31 sets a trajectory to be traveled by the vehicle 10 in a predetermined section from the current position of the vehicle 10 to a predetermined distance (e.g., 500 m to 1 km) ahead thereof (hereafter simply a “planned trajectory”), and calculates target acceleration/deceleration and target deceleration for the vehicle 10 to travel along the planned trajectory. The planned trajectory is represented, for example, as a set of target positions of the vehicle 10 at respective time points during travel of the vehicle 10 through the predetermined section.

The driving planning unit 31 sets the planned trajectory, for example, so as to follow a planned travel route. More specifically, when the planned travel route does not include a location where the vehicle will turn right or left in the nearest predetermined section, the driving planning unit 31 sets the planned trajectory so that the vehicle 10 will travel on the current travel lane. When the planned travel route includes a location where the vehicle will turn right or left in the nearest predetermined section, the driving planning unit 31 sets the planned trajectory so that the vehicle 10 can turn right or left at this location. In this case, when the vehicle 10 needs to move to a target lane different from the travel lane of the vehicle 10 to turn right or left, the driving planning unit 31 sets the planned trajectory so that the vehicle 10 will change lanes to the target lane. The driving planning unit 31 identifies the current travel lane and the current position of the vehicle 10 by comparing features represented in an image of the surroundings of the vehicle 10 obtained by the camera provided for the vehicle 10 with features around the vehicle 10 represented in the map information.

Additionally, the driving planning unit 31 sets the planned trajectory so that the vehicle 10 will not collide with surrounding objects (e.g., other vehicles). For this purpose, the driving planning unit 31 inputs time-series images obtained by the camera mounted on the vehicle 10 in a preceding predetermined period into a classifier that has been trained to detect objects around the vehicle 10, thereby detecting one or more objects around the vehicle 10 from each image. Alternatively, the driving planning unit 31 inputs time-series ranging signals obtained by the distance sensor in a preceding predetermined period into a classifier that has been trained to detect objects around the vehicle 10, thereby detecting one or more objects around the vehicle 10 from each ranging signal. As such a classifier, the driving planning unit 31 may use, for example, a “deep neural network” (hereafter simply a “DNN”) having a convolutional neural network (hereafter simply “CNN”) architecture. Such a classifier is trained in advance with a large number of images or ranging signals representing detection target objects in accordance with a training technique, such as backpropagation. The driving planning unit 31 executes a predetermined tracking process on individual objects detected from each image or ranging signal, thereby tracking these objects to determine their trajectories in the preceding predetermined period. The driving planning unit 31 then applies a predetermined prediction process to the determined trajectories to estimate predicted trajectories along which the respective objects are expected to travel. The driving planning unit 31 sets the planned trajectory of the vehicle 10, based on the predicted trajectories of the tracked objects, so that a predicted distance between the vehicle 10 and any of the tracked objects will be not less than a predetermined distance until a predetermined time ahead.

Additionally, the driving planning unit 31 detects the lighting state of a traffic light in the travel direction of the vehicle 10 from images obtained by the camera provided for the vehicle 10. Specifically, the driving planning unit 31 inputs each image into a classifier, as described above, to detect the lighting state of a traffic light. When the detected lighting state of a traffic light is red, the driving planning unit 31 sets the planned trajectory so as to decelerate the vehicle 10 and stop it at a stop position of the intersection where the traffic light is located. When the vehicle 10 is stopped at an intersection because of a red light and a change in the lighting state of the traffic light from red to green is detected, the driving planning unit 31 sets the planned trajectory so that the vehicle 10 will start and gradually accelerate.

Upon setting the planned trajectory, the driving planning unit 31 determines target acceleration/deceleration and target deceleration so that the vehicle 10 will travel along the planned trajectory. More specifically, the target acceleration/deceleration and the target deceleration are values required of the vehicle 10 under automated driving control of the vehicle 10. For example, the driving planning unit 31 calculates the target acceleration/deceleration and the target deceleration of the vehicle 10 at predetermined intervals, depending on the planned trajectory, the current position of the vehicle 10, and the current vehicle speed of the vehicle 10 measured by the vehicle speed sensor (not illustrated). In particular, when the vehicle 10 is decelerated due to requirements for automated driving control, the driving planning unit 31 sets the target acceleration/deceleration at a value indicating deceleration, and also calculates the target deceleration, depending on the target acceleration/deceleration. For example, at decelerating the vehicle 10, the driving planning unit 31 calculates the target acceleration/deceleration and the target deceleration so that the resultant of braking force adjustable by the accelerator controller 3 (e.g., braking force caused by engine braking) and braking force caused by the brake may achieve deceleration for the vehicle 10 to travel along the planned trajectory. In particular, the driving planning unit 31 sets the target acceleration/deceleration to be not greater than the upper limit of the braking force adjustable by the accelerator controller 3, and the target deceleration to equal deceleration for the vehicle 10 to travel along the planned trajectory. Additionally, the driving planning unit 31 may calculate the steering angle of the steering of the vehicle 10 so that the vehicle 10 will travel along the planned trajectory, and output a control signal indicating the steering angle via the communication interface 21 to the controller for controlling the steering.

Every time it calculates the target acceleration/deceleration and the target amount of braking, the driving planning unit 31 passes the calculated target acceleration/deceleration to the acceleration/deceleration request modification unit 32 and the braking request modification unit 33, and the calculated target deceleration to the braking request modification unit 33.

The acceleration/deceleration request modification unit 32 modifies the target acceleration/deceleration included in an acceleration/deceleration request signal received via the communication interface 21 from the driving assistance controller 2 to a value indicating the target acceleration/deceleration calculated by the driving planning unit 31 and required of the vehicle 10 in automated driving control of the vehicle 10. The acceleration/deceleration request modification unit 32 outputs the modified acceleration/deceleration request signal via the communication interface 21 to the accelerator controller 3.

The braking request modification unit 33 modifies the target deceleration included in a braking request signal received via the communication interface 21 from the accelerator controller 3 to the target deceleration calculated by the driving planning unit 31 and required of the vehicle 10 in automated driving control of the vehicle 10. The braking request modification unit 33 outputs the modified braking request signal via the communication interface 21 to the brake controller 4.

When the vehicle 10 is accelerated due to requirements for automated driving control, the target deceleration is generally a value indicating acceleration (e.g., a positive value). In this case, the brake controller 4 does nothing even when a braking request signal is received. Thus, when both the target deceleration included in a braking request signal received from the accelerator controller 3 and the modified target acceleration/deceleration calculated by the driving planning unit 31 are values indicating acceleration of the vehicle 10, the braking request modification unit 33 need not modify the braking request signal received from the accelerator controller 3.

As described above, when the vehicle 10 at rest starts, the vehicle 10 preferably accelerates and also applies the brake to a certain extent for the purpose of a smooth start, and gradually releases the brake. Thus, in such a case, there is a possibility that the modified target acceleration/deceleration calculated by the driving planning unit 31 is a value indicating acceleration whereas the target deceleration included in a braking request signal received from the accelerator controller 3 is a value indicating deceleration (e.g., a negative value). In this case, if a signal indicating that the brake has not operated is outputted from the brake controller 4 to the accelerator controller 3, it may cause an error of the accelerator controller 3. Thus, in such a case, the braking request modification unit 33 preferably omits to modify the target deceleration included in the braking request signal received from the accelerator controller 3.

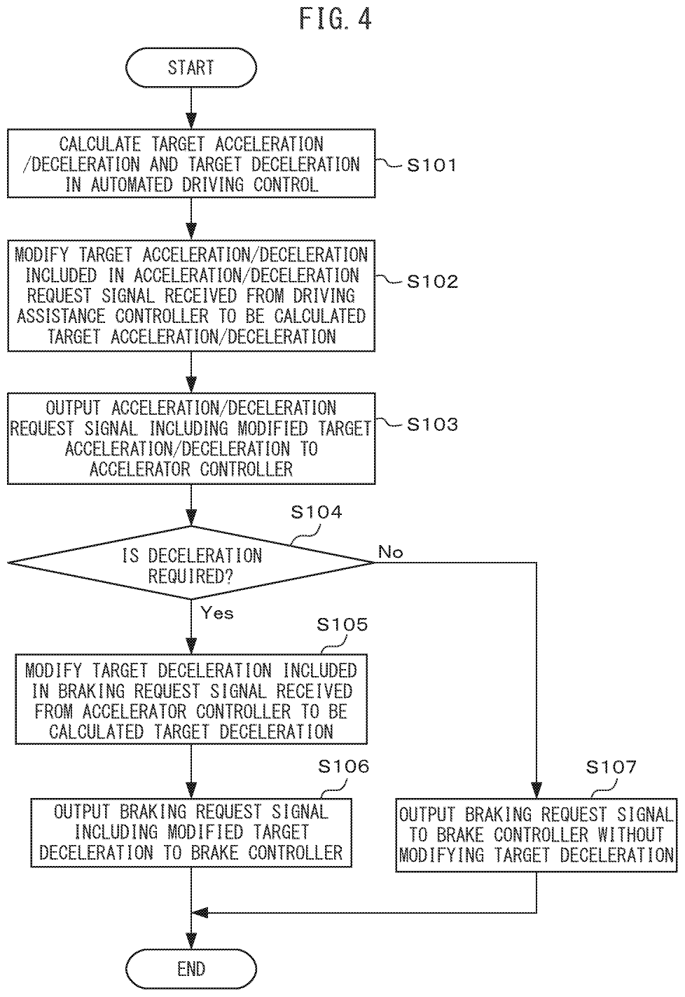

FIG. 4 is an operation flowchart of the vehicle control process executed by the processor 23. During automated driving control of the vehicle 10, the processor 23 executes the vehicle control process at predetermined intervals in accordance with the following operation flowchart.

The driving planning unit 31 of the processor 23 calculates target acceleration/deceleration and target deceleration for the vehicle 10 to travel along a planned trajectory in automated driving control of the vehicle 10 (step S101).

The acceleration/deceleration request modification unit 32 of the processor 23 modifies the target acceleration/deceleration included in an acceleration/deceleration request signal received via the communication interface 21 from the driving assistance controller 2 to be the target acceleration/deceleration calculated by the driving planning unit 31 (step S102). The acceleration/deceleration request modification unit 32 outputs an acceleration/deceleration request signal including the modified target acceleration/deceleration via the communication interface 21 to the accelerator controller 3 (step S103).

The braking request modification unit 33 of the processor 23 determines whether the vehicle 10 is required to decelerate for the purpose of automated driving control, by referring to the target acceleration/deceleration calculated by the driving planning unit 31 (step S104). When the vehicle 10 is required to decelerate (Yes in Step S104), the braking request modification unit 33 modifies the target deceleration included in a braking request signal received via the communication interface 21 from the accelerator controller 3 to be the target deceleration calculated by the driving planning unit 31 (step S105). The braking request modification unit 33 outputs a braking request signal including the modified target deceleration via the communication interface 21 to the brake controller 4 (step S106).

When the vehicle 10 is not required to decelerate (No in Step S104), the braking request modification unit 33 outputs to the brake controller 4 a braking request signal received via the communication interface 21 from the accelerator controller 3 without modifying it (step S107). After step S106 or S107, the processor 23 terminates the vehicle control process.

As has been described above, the device of the vehicle modifies the target acceleration/deceleration included in an acceleration/deceleration request signal received from the driving assistance controller and the target deceleration included in a braking request signal received from the accelerator controller to values required in automated driving control of the vehicle. The control device then controls the vehicle according to an acceleration/deceleration request including the modified target acceleration/deceleration and a braking request including the modified target deceleration. Thus, the control device enables automated driving control of the vehicle with the driving assistance controller.

In the embodiment, the accelerator controller 3 generates a braking request signal, depending on a received acceleration/deceleration request signal. However, according to a modified example, the driving assistance controller 2 may generate not only an acceleration/deceleration request signal but also a braking request signal. In this case, the braking request modification unit 33 modifies the target deceleration included in a braking request signal received via the communication interface 21 from the driving assistance controller 2 to equal the target deceleration calculated by the driving planning unit 31.

According to another modified example, even when the target acceleration/deceleration calculated by the driving planning unit 31 indicates that the vehicle 10 is required to accelerate for the purpose of automated driving control, the braking request modification unit 33 may modify the target deceleration included in a received braking request signal to equal the target deceleration calculated by the driving planning unit 31.

As described above, those skilled in the art may make various modifications according to embodiments within the scope of the present invention.

What is claimed is:

1. A control device of a vehicle, comprising:
a processor configured to:
modify target acceleration/deceleration of the vehicle according to acceleration/deceleration required of the vehicle in automated driving control of the vehicle, the target acceleration/deceleration being included in a first acceleration/deceleration request received via a communication interface from a driving assistance controller for assisting a driver of the vehicle in driving, and
output a second acceleration/deceleration request including the modified target acceleration/deceleration via the communication interface to an accelerator controller for controlling an accelerator of the vehicle.

2. The control device according to claim 1, wherein the processor is further configured to modify target deceleration of the vehicle by braking force of a brake of the vehicle according to deceleration by braking force of the brake required in automated driving control of the vehicle, the target deceleration being included in a first braking request received via the communication interface, and output a second braking request including the modified target deceleration via the communication interface to a brake controller for controlling the brake.

3. The control device according to claim 2, wherein when the acceleration/deceleration required of the vehicle in automated driving control of the vehicle indicates deceleration of the vehicle, the processor modifies the target deceleration included in the first braking request according to the deceleration by braking force of the brake required in automated driving control of the vehicle, and when the acceleration/deceleration required of the vehicle in automated driving control of the vehicle indicates acceleration of the vehicle, the processor does not modify the target deceleration included in the first braking request.

4. A method for controlling a vehicle, comprising:
modifying target acceleration/deceleration of the vehicle according to acceleration/deceleration required of the vehicle in automated driving control of the vehicle, the target acceleration/deceleration being included in a first acceleration/deceleration request received via a communication interface from a driving assistance controller for assisting a driver of the vehicle in driving; and
outputting a second acceleration/deceleration request including the modified target acceleration/deceleration via the communication interface to an accelerator controller for controlling an accelerator of the vehicle.
